(19) United States
(12) Patent Application Publication
(10) Pub. No.: US 2016/0050267 A1
(43) Pub. Date: Feb. 18, 2016

(54) Sign-In Method and Terminal

(71) Applicant: Huawei Device Co., Ltd., Shenzhen (CN)

(72) Inventors: Ji Chen, Shenzhen (CN); Zhiming Ding, Shenzhen (CN)

(21) Appl. No.: 14/923,577

(22) Filed: Oct. 27, 2015

Related U.S. Application Data
(63) Continuation of application No. PCT/CN2014/075889, filed on Apr. 22, 2014.

(30) Foreign Application Priority Data
Apr. 28, 2013 (CN) 201310157810.3

(51) Int. Cl. H04L 29/08; G06Q 10/10; H04L 12/26

(52) U.S. Cl. CPC H04L 67/1046; H04L 43/10; G06Q 10/1091

(57) ABSTRACT

A sign-in method includes receiving, by a first terminal, a sign-in request message sent by a second terminal, where the sign-in request message carries an identifier (ID) of an activity and an ID of a user of the second terminal, and the sign-in request message is used to indicate that the user of the second terminal requests to sign in to the activity in the first terminal; and sending a sign-in response message to the second terminal, where the sign-in response message carries the ID of the activity, and the sign-in response message is used to indicate that the user of the second terminal successfully signs in to the activity in the first terminal.

### CROSS-REFERENCE TO RELATED APPLICATIONS

This application is a continuation of International Application No. PCT/CN2014/075889, filed on Apr. 22, 2014, which claims priority to Chinese Patent Application No. 201310157810.3, filed on Apr. 28, 2013, both of which are incorporated herein by reference in their entireties.

### TECHNICAL FIELD

The present disclosure relates to the field of computer technologies, and in particular, to a sign-in method and a terminal.

### BACKGROUND

Currently, when organizing an activity or a conference, an organizer generally needs to record attendance of participants, and such a process may be referred to as sign-in. For example, a unit organizes a spring outing, and predetermines a meeting time and a meeting place. When the predetermined meeting time will arrive, one or more persons are particularly arranged at the predetermined meeting place to be responsible for sign-in of participants, and names of the participants may be signed on a sign-in sheet for subsequent recording and statistics.

Such a manual sign-in method increases human resource consumption, because one or more persons need to be arranged particularly to be responsible for sign-in; when there are many participants, sign-in efficiency is reduced; and mistakes are inevitably made due to manual sign-in, which reduces sign-in accuracy and is adverse to subsequently collect statistics about information of the participants. As a result, using the manual sign-in method leads to high human resource consumption, low sign-in efficiency, and inaccurate sign-in.

### SUMMARY

Embodiments of the present disclosure provide a sign-in method and a terminal, which are used to solve problems in the prior art that using a manual sign-in manner leads to high human resource consumption, low sign-in efficiency, and inaccurate sign-in.

According to a first aspect, a sign-in method is provided, including receiving, by a first terminal, a sign-in request message sent by a second terminal, where the sign-in request message carries an identifier (ID) of an activity and an ID of a user of the second terminal, and the sign-in request message is used to indicate that the user of the second terminal requests to sign in to the activity in the first terminal; and sending a sign-in response message to the second terminal, where the sign-in response message carries the ID of the activity, and the sign-in response message is used to indicate that the user of the second terminal successfully signs in to the activity in the first terminal.

With reference to the first aspect, in a first possible implementation manner, the first terminal receives, using a Wireless Fidelity (WiFi) network, the sign-in request message that is sent by the second terminal using the WiFi network; and sends the sign-in response message to the second terminal using the WiFi network.

With reference to the first aspect or the first possible implementation manner of the first aspect, in a second possible implementation manner, before the receiving, by a first terminal, a sign-in request message, the method further includes acquiring, by the first terminal, the ID of the activity and a start time of the activity; and the receiving, by the first terminal, the sign-in request message includes receiving, by the first terminal, the sign-in request message at or after a set moment before the start time of the activity arrives.

With reference to the second possible implementation manner of the first aspect, in a third possible implementation manner, before the receiving, by a first terminal, a sign-in request message, the method further includes sending, by the first terminal, the acquired ID of the activity and the acquired start time of the activity to the second terminal.

With reference to the first aspect, the first possible implementation manner of the first aspect, the second possible implementation manner of the first aspect, or the third possible implementation manner of the first aspect, in a fourth possible implementation manner, after the receiving, by the first terminal, the sign-in request message, and before the sending a sign-in response message, the method further includes authenticating, by the first terminal, validity of the ID of the user of the second terminal.

With reference to the first aspect, the first possible implementation manner of the first aspect, the second possible implementation manner of the first aspect, the third possible implementation manner of the first aspect, or the fourth possible implementation manner of the first aspect, in a fifth possible implementation manner, before the receiving, by the first terminal, the sign-in request message, the method further includes receiving, by the first terminal, a discovery request message that carries the ID of the activity and is sent by the second terminal, and sending, to the second terminal, a discovery response message carrying the ID of the activity, where the discovery request message is used by the second terminal to discover the first terminal, and the discovery response message is used to enable the second terminal to determine that the first terminal is discovered; or broadcasting, by the first terminal, a sign-in paging message carrying the ID of the activity, where the sign-in paging message is used to indicate that the first terminal pages another terminal to sign in to the activity.

With reference to the first aspect, the first possible implementation manner of the first aspect, the second possible implementation manner of the first aspect, the third possible implementation manner of the first aspect, the fourth possible implementation manner of the first aspect, or the fifth possible implementation manner of the first aspect, in a sixth possible implementation manner, after the receiving, by the first terminal, the sign-in request message, the method further includes adding, by the first terminal, a sign-in mark to the ID of the user of the second terminal, where the ID of the user of the second terminal is included in the sign-in request message.

With reference to the first aspect, the first possible implementation manner of the first aspect, the second possible implementation manner of the first aspect, the third possible implementation manner of the first aspect, the fourth possible implementation manner of the first aspect, the fifth possible implementation manner of the first aspect, or the sixth possible implementation manner of the first aspect, in a seventh possible implementation manner, after the sending, by the first terminal, the sign-in response message to the second terminal, the method further includes, if the first terminal does not receive, within specified duration, a heartbeat report message sent by the second terminal, determining, by the first terminal, that the user of the second terminal leaves the activity, and adding a leave mark to the ID of the user of the second terminal.

With reference to the seventh possible implementation manner of the first aspect, in an eighth possible implementation manner, the method further includes, after the activity ends, collecting, by the first terminal according to a quantity of IDs of users that have the sign-in mark and the leave mark, statistics about a level of participation of the users in the activity.

According to a second aspect, a sign-in method is provided, including sending, by a second terminal, a sign-in request message to a first terminal, where the sign-in request message carries an ID of an activity and an ID of a user of the second terminal, and the sign-in request message is used to indicate that the user of the second terminal requests to sign in to the activity in the first terminal; and receiving a sign-in response message sent by the first terminal, where the sign-in response message carries the ID of the activity, and the sign-in response message is used to indicate that the user of the second terminal successfully signs in to the activity in the first terminal.

With reference to the second aspect, in a first possible implementation manner, the second terminal sends the sign-in request message to the first terminal using a WiFi network; and receives, using the WiFi network, the sign-in response message that is sent by the first terminal using the WiFi network.

With reference to the second aspect or the first possible implementation manner of the second aspect, in a second possible implementation manner, before the sending, by a second terminal, a sign-in request message to a first terminal, the method further includes acquiring, by the second terminal, a start time of the activity; and the sending, by a second terminal, a sign-in request message to a first terminal includes sending, by the second terminal, the sign-in request message to the first terminal at or after a set moment before the start time of the activity arrives.

With reference to the second aspect, the first possible implementation manner of the second aspect, or the second possible implementation manner of the second aspect, in a third possible implementation manner, the ID of the activity carried in the sign-in request message that is sent by the second terminal to the first terminal is sent by the first terminal to the second terminal.

With reference to the second aspect, the first possible implementation manner of the second aspect, the second possible implementation manner of the second aspect, or the third possible implementation manner of the second aspect, in a fourth possible implementation manner, before the sending, by a second terminal, a sign-in request message to a first terminal, the method further includes sending, by the second terminal to the first terminal, a discovery request message carrying the ID of the activity, and receiving a discovery response message that carries the ID of the activity and is sent by the first terminal, where the discovery request message is used by the second terminal to discover the first terminal, and the discovery response message is used to enable the second terminal to determine that the first terminal is discovered; or receiving, by the second terminal, a sign-in paging message that carries the ID of the activity and is broadcast by the first terminal, where the sign-in paging message is used to indicate that the first terminal pages another terminal to sign in to the activity.

With reference to the second aspect, the first possible implementation manner of the second aspect, the second possible implementation manner of the second aspect, the third possible implementation manner of the second aspect, or the fourth possible implementation manner of the second aspect, in a fifth possible implementation manner, after the receiving, by the second terminal, a sign-in response message sent by the first terminal, the method further includes, in a process in which the user of the second terminal participates in the activity, sending, by the second terminal, a heartbeat report message to the first terminal according to a set time period, and receiving a heartbeat acknowledgement message sent by the first terminal.

With reference to the second aspect, the first possible implementation manner of the second aspect, the second possible implementation manner of the second aspect, the third possible implementation manner of the second aspect, the fourth possible implementation manner of the second aspect, or the fifth possible implementation manner of the second aspect, in a sixth possible implementation manner, after the receiving, by the second terminal, a sign-in response message sent by the first terminal, the method further includes receiving, by the second terminal, a notification message that is sent by the first terminal and is used to notify the second terminal that the activity has ended.

According to a third aspect, a terminal is provided, including a receiving module configured to receive a sign-in request message sent by a second terminal, where the sign-in request message carries an ID of an activity and an ID of a user of the second terminal, and the sign-in request message is used to indicate that the user of the second terminal requests to sign in to the activity in a first terminal in which the terminal is located; and a sending module configured to send a sign-in response message to the second terminal, where the sign-in response message carries the ID of the activity, and the sign-in response message is used to indicate that the user of the second terminal successfully signs in to the activity in the first terminal.

With reference to the third aspect, in a first possible implementation manner, the receiving module is configured to receive, using a WiFi network, the sign-in request message that is sent by the second terminal using the WiFi network; and the sending module is configured to send the sign-in response message to the second terminal using the WiFi network.

With reference to the third aspect or the first possible implementation manner of the third aspect, in a second possible implementation manner, the terminal further includes an acquiring module configured to acquire the ID of the activity and a start time of the activity before the receiving module receives the sign-in request message; and the receiving module is configured to receive the sign-in request message at or after a set moment before the start time of the activity arrives.

With reference to the second possible implementation manner of the third aspect, in a third possible implementation manner, the sending module is further configured to send, before the receiving module receives the sign-in request message, the acquired ID of the activity and the acquired start time of the activity to the second terminal.

With reference to the third aspect, the first possible implementation manner of the third aspect, the second possible implementation manner of the third aspect, or the third possible implementation manner of the third aspect, in a fourth possible implementation manner, the terminal further includes an authentication module configured to authenticate validity of the ID of the user of the second terminal after the receiving module receives the sign-in request message and before the sending module sends the sign-in response message.

With reference to the third aspect, the first possible implementation manner of the third aspect, the second possible implementation manner of the third aspect, the third possible implementation manner of the third aspect, or the fourth possible implementation manner of the third aspect, in a fifth possible implementation manner, the receiving module is further configured to receive, before receiving the sign-in request message, a discovery request message that carries the ID of the activity and is sent by the second terminal, where the discovery request message is used by the second terminal to discover the first terminal; and the sending module is further configured to send, to the second terminal before the receiving module receives the sign-in request message, a discovery response message carrying the ID of the activity, where the discovery response message is used to enable the second terminal to determine that the first terminal is discovered.

With reference to the third aspect, the first possible implementation manner of the third aspect, the second possible implementation manner of the third aspect, the third possible implementation manner of the third aspect, or the fourth possible implementation manner of the third aspect, in a sixth possible implementation manner, the sending module is further configured to broadcast a sign-in paging message carrying the ID of the activity, where the sign-in paging message is used to indicate that the first terminal pages another terminal to sign in to the activity.

With reference to the third aspect, the first possible implementation manner of the third aspect, the second possible implementation manner of the third aspect, the third possible implementation manner of the third aspect, the fourth possible implementation manner of the third aspect, the fifth possible implementation manner of the third aspect, or the sixth possible implementation manner of the third aspect, in a seventh possible implementation manner, the terminal further includes a sign-in module configured to add, after the receiving module receives the sign-in request message, a sign-in mark to the ID of the user of the second terminal, where the ID of the user of the second terminal is included in the sign-in request message.

With reference to the third aspect, the first possible implementation manner of the third aspect, the second possible implementation manner of the third aspect, the third possible implementation manner of the third aspect, the fourth possible implementation manner of the third aspect, the fifth possible implementation manner of the third aspect, the sixth possible implementation manner of the third aspect, or the seventh possible implementation manner of the third aspect, in an eighth possible implementation manner, the sign-in module is further configured to, after the sending module sends the sign-in response message to the second terminal, if a heartbeat report message sent by the second terminal is not received within specified duration, determine that the user of the second terminal leaves the activity, and add a leave mark to the ID of the user of the second terminal.

With reference to the eighth possible implementation manner of the third aspect, in a ninth possible implementation manner, the sign-in module is further configured to, after the activity ends, collect, according to a quantity of IDs of users that have the sign-in mark and the leave mark, statistics about a level of participation of the users in the activity.

According to a fourth aspect, a terminal is provided, including a sending module configured to send a sign-in request message to a first terminal, where the sign-in request message carries an ID of an activity and an ID of a user of a second terminal in which the terminal is located, and the sign-in request message is used to indicate that the user of the second terminal requests to sign in to the activity in the first terminal; and a receiving module configured to receive a sign-in response message sent by the first terminal, where the sign-in response message carries the ID of the activity, and the sign-in response message is used to indicate that the user of the second terminal successfully signs in to the activity in the first terminal.

With reference to the fourth aspect, in a first possible implementation manner, the sending module is configured to send the sign-in request message to the first terminal using a WiFi network; and the receiving module is configured to receive, using the WiFi network, the sign-in response message that is sent by the first terminal using the WiFi network.

With reference to the fourth aspect or the first possible implementation manner of the fourth aspect, in a second possible implementation manner, the terminal further includes an acquiring module configured to acquire a start time of the activity before the sending module sends the sign-in request message to the first terminal; and the sending module is configured to send the sign-in request message to the first terminal at or after a set moment before the start time of the activity arrives.

With reference to the fourth aspect, the first possible implementation manner of the fourth aspect, or the second possible implementation manner of the fourth aspect, in a third possible implementation manner, the ID of the activity carried in the sign-in request message that is sent by the sending module to the first terminal is sent by the first terminal to the second terminal.

With reference to the fourth aspect, the first possible implementation manner of the fourth aspect, the second possible implementation manner of the fourth aspect, or the third possible implementation manner of the fourth aspect, in a fourth possible implementation manner, the sending module is further configured to send, to the first terminal before sending the sign-in request message to the first terminal, a discovery request message carrying the ID of the activity, where the discovery request message is used by the second terminal to discover the first terminal; and the receiving module is further configured to receive, before the sending module sends the sign-in request message to the first terminal, a discovery response message that carries the ID of the activity and is sent by the first terminal, where the discovery response message is used to enable the second terminal to determine that the first terminal is discovered.

With reference to the fourth aspect, the first possible implementation manner of the fourth aspect, the second possible implementation manner of the fourth aspect, or the third possible implementation manner of the fourth aspect, in a fifth possible implementation manner, the receiving module is further configured to receive a sign-in paging message that carries the ID of the activity and is broadcast by the first terminal, where the sign-in paging message is used to indicate that the first terminal pages another terminal to sign in to the activity.

With reference to the fourth aspect, the first possible implementation manner of the fourth aspect, the second possible implementation manner of the fourth aspect, the third possible implementation manner of the fourth aspect, the fourth possible implementation manner of the fourth aspect, or the fifth possible implementation manner of the fourth aspect, in a sixth possible implementation manner, the sending module is further configured to, after the receiving module receives the sign-in response message sent by the first terminal, in a process in which the user of the second terminal participates in the activity, send a heartbeat report message to the first terminal according to a set time period; and the receiving module is further configured to receive a heartbeat acknowledgement message sent by the first terminal.

With reference to the fourth aspect, the first possible implementation manner of the fourth aspect, the second possible implementation manner of the fourth aspect, the third possible implementation manner of the fourth aspect, the fourth possible implementation manner of the fourth aspect, or the fifth possible implementation manner of the fourth aspect, in a sixth possible implementation manner, the receiving module is further configured to receive, after receiving the sign-in response message sent by the first terminal, a notification message that is sent by the first terminal and is used to notify the second terminal that the activity has ended.

According to the sign-in method provided in the first aspect, the sign-in method provided in the second aspect, the terminal provided in the third aspect, or the terminal provided in the fourth aspect, automatic sign-in can be implemented without needing to assign a person to be particularly responsible for sign-in any longer, thereby saving a human resource; even though there are many participants, a first terminal can still perform sign-in in time for a participant that uses a second terminal, thereby improving sign-in efficiency; and it is less likely to make a mistake, so that sign-in accuracy is improved, and it is beneficial to subsequently collect statistics about a level of participation of participants.

### BRIEF DESCRIPTION OF DRAWINGS

FIG. 1 is a flowchart of a sign-in method according to an embodiment of the present disclosure;

FIG. 2 is a flowchart of a method for authenticating a second terminal by a first terminal according to an embodiment of the present disclosure;

FIG. 3 is a flowchart of a sign-in method that is performed by a first terminal according to an embodiment of the present disclosure;

FIG. 4 is a flowchart of a sign-in method that is performed by a second terminal according to an embodiment of the present disclosure;

FIG. 5 is a schematic structural diagram of a first type of terminal according to an embodiment of the present disclosure;

FIG. 6 is a schematic structural diagram of an exemplary implementation manner of a first type of terminal according to an embodiment of the present disclosure;

FIG. 7 is a schematic structural diagram of a second type of terminal according to an embodiment of the present disclosure; and

FIG. 8 is a schematic structural diagram of an exemplary implementation manner of a second type of terminal according to an embodiment of the present disclosure.

### DESCRIPTION OF EMBODIMENTS

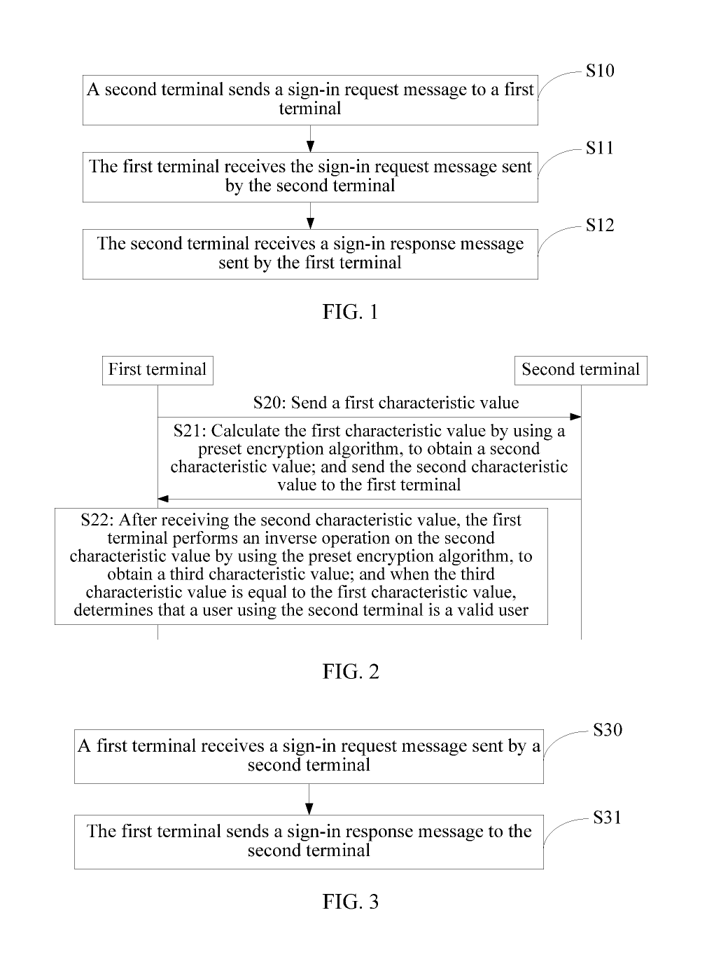

An embodiment of the present disclosure provides a sign-in method. A process of the method is shown in FIG. 1, and steps are performed as follows.

S10: A second terminal sends a sign-in request message to a first terminal, where the sign-in request message carries an ID of an activity and an ID of a user of the second terminal.

Each activity has an organizer and a participant, the first terminal is a terminal used by the organizer, the second terminal is a terminal used by the participant, the participant is a user of the second terminal, the first terminal and the second terminal may be devices such as mobile phones or tablet computers, and generally, there is only one first terminal, but there may be multiple second terminals.

When a sign-in time arrives or a user of the second terminal triggers sign-in, the second terminal starts to request to sign in to, for the user of the second terminal and in the first terminal, an activity in which the user of the second terminal is to participate. When sign-in is performed for the user of the second terminal, the second terminal sends a sign-in request message to the first terminal, where the sign-in request message carries an ID of the activity and an ID of the user of the second terminal, the sign-in request message is used to indicate that the user of the second terminal requests to sign in to the activity in the first terminal, and the ID of the activity may indicate the activity in which the user of the second terminal is to participate.

The ID of the user of the second terminal may be an ID of the user using the second terminal, or may be an ID of a device of the second terminal. For example, if the first terminal sends the ID of the activity to the second terminal using a short message service message, a mobile phone number of the user of the second terminal is the ID of the user of the second terminal; if the ID of the activity is sent to the second terminal using a QQ message, a QQ number of the user of the second terminal is the ID of the user of the second terminal; and if the ID of the activity is sent to the second terminal by means of Near Field Communication (NFC), the first terminal may record an ID of a device of the second terminal, and the ID of the device of the second terminal is used as the ID of the user of second terminal.

S11: The first terminal receives the sign-in request message sent by the second terminal, and sends a sign-in response message to the second terminal, where the sign-in response message carries the ID of the activity, and the sign-in response message is used to indicate that the user of the second terminal successfully signs in to the activity in the first terminal.

The first terminal receives the sign-in request message sent by the second terminal, can perform sign-in for the user of the second terminal according to the ID of the activity and the ID of the user of the second terminal that are carried in the sign-in request message, and sends the sign-in response message to the second terminal after the sign-in is successful; in this way, sign-in to the activity for the user of the second terminal is completed.

S12: The second terminal receives the sign-in response message sent by the first terminal.

A WiFi network may be used in the foregoing process of the method, that is, the second terminal sends the sign-in request message to the first terminal using the WiFi network; the first terminal receives the sign-in request message using the WiFi network, and sends the sign-in response message to the second terminal using the WiFi network; and the second terminal receives, using the WiFi network, the sign-in response message sent by the first terminal.

Sending the sign-in request message and receiving the sign-in response message using the WiFi network herein refers to sending the sign-in request message and receiving the sign-in response message through an air interface of WiFi. For example, sending and receiving, through an air interface of WiFi, a message between two terminals that both have a WiFi function.

A transmission range of WiFi is related to transmit power of WiFi, which generally may be tens of meters to hundreds of meters, and sometimes may be tens or hundreds of kilometers. For a device having a long-distance transmission capability, transmit power may be adjusted to implement short-distance discovery and sign-in of tens to hundreds of meters, or implement long-distance discovery and sign-in of tens or hundreds of kilometers.

According to the foregoing sign-in method, automatic sign-in can be implemented, where a second terminal may request to sign in to an activity for a user of the second terminal in a first terminal, and after receiving a sign-in request message sent by the second terminal, the first terminal returns a sign-in response message to the second terminal; in this way, sign-in for the user of the second terminal is implemented without needing to assign a person to be particularly responsible for sign-in for the user of the second terminal any longer, thereby saving a human resource; because the first terminal can immediately perform sign-in for the user of the second terminal when receiving the sign-in request message sent by the second terminal, even though there are many participants in the activity, the first terminal can still perform sign-in in time for a participant that uses the second terminal, thereby improving sign-in efficiency; and because the sign-in request message carries an ID of the activity and an ID of the user of the second terminal, the first terminal performs sign-in for the user of the second terminal only after receiving the sign-in request message of the ID of the activity, where the ID of the activity is stored in the first terminal, such that no mistake is made, sign-in accuracy is improved, and it is beneficial to subsequently collect statistics about information of participants.

Optionally, before the second terminal sends the sign-in request message to the first terminal in S10 in the foregoing, the method may further include that the second terminal acquires a start time of the activity.

That the second terminal sends the sign-in request message to the first terminal in S10 in the foregoing may include that the second terminal sends the sign-in request message to the first terminal at or after a set moment before the start time of the activity arrives, and the first terminal receives the sign-in request message sent by the second terminal.

After acquiring the start time of the activity, the second terminal may send the sign-in request message to the first terminal at or after the set moment before the start time of the activity arrives. The set moment may be set according to an actual need, and for example, the set moment may be set to 10 minutes, 20 minutes, or the like before the activity starts; in this way, even though there is a participant that arrives ahead of schedule, sign-in for the participant can still be implemented. The set moment may be set to 0 minutes before the activity starts, which indicates that sign-in starts on time when the activity starts.

The ID of the activity carried in the sign-in request message that is sent by the second terminal to the first terminal may be sent by the first terminal to the second terminal, or may be directly provided by an organizer of the activity for the second terminal. For example, software for automatically discovering various activities is installed in the second terminal, and an activity discovered by the second terminal carries an ID of the activity; or the second terminal scans a Quick Response (QR) code that carries an ID of the activity, such that the ID of the activity may be acquired.

Before the first terminal receives the sign-in request message in S11 in the foregoing, the method further includes that the first terminal acquires the ID of the activity and the start time of the activity.

The first terminal may acquire the ID of the user of the second terminal in the following two manners.

A first manner is a planned manner, in which an organizer searches a contact list of the first terminal for or manually input an ID of a possible participant, or the like. In this manner, possible participants are known when creating an activity, and invitations are sent to these possible participants, and an invitation manner may be sending short message service messages, sending QQ messages, or sending voice messages; and persons accepting the invitations are considered to be participants, that is, users of the second terminal, and IDs of the users of the second terminal are saved.

A second manner is an unplanned manner, in which a specific participant is unknown when creating an activity, and persons are invited temporarily to participate during the activity. For example, a product seminar is held in a shopping mall, and on-site consumers are invited temporarily to participate, where consumers accepting the invitations are participants, that is, users of the second terminal, and IDs of the users of the second terminal may be added to the first terminal by a staff member, such that the first terminal may also acquire the IDs of the users of the second terminal.

Optionally, after the first terminal receives the sign-in request message in S11 in the foregoing, and before the first terminal sends the sign-in response message, the method may further include that the first terminal authenticates validity of the ID of the user of the second terminal. An authentication process is shown in FIG. 2, including the following steps.

S20: The first terminal sends a first characteristic value to the second terminal.

The first terminal may randomly select a characteristic value and send the characteristic value to the second terminal.

S21: After receiving the first characteristic value, the second terminal calculates the first characteristic value using a preset encryption algorithm, to obtain a second characteristic value; and sends the second characteristic value to the first terminal.

The preset encryption algorithm may be sent by the first terminal to the second terminal. When the first terminal and the second terminal have a same encryption algorithm, the preset encryption algorithm may also be the encryption algorithm of the first terminal and the second terminal.

S22: After receiving the second characteristic value, the first terminal performs an inverse operation on the second characteristic value using the preset encryption algorithm, to obtain a third characteristic value; and when the third characteristic value is equal to the first characteristic value, determines that a user using the second terminal is a valid user.

After receiving the second characteristic value, the first terminal performs the inverse operation using the preset encryption algorithm, to obtain the third characteristic value; and then determines, by means of comparison, whether the first characteristic value and the third characteristic value are equal; if the first characteristic value and the third characteristic value are equal, it indicates that the user using the second terminal is a valid user; and if the first characteristic value and the third characteristic value are not equal, it indicates that the user using the second terminal is not a valid user, and the first terminal may not return a sign-in response message to the user, which means that the first terminal does not perform sign-in for the user. In this way, sign-in for a valid user participating in the activity can be ensured, thereby ensuring sign-in accuracy.

Optionally, before the second terminal sends the sign-in request message to the first terminal in S10 in the foregoing, the method may further include either one of the following two manners.

A first manner: the second terminal sends a discovery request message carrying the ID of the activity; the first terminal receives the discovery request message that carries the ID of the activity and is sent by the second terminal, and sends, to the second terminal, a discovery response message carrying the ID of the activity, where the discovery request message is used by the second terminal to discover the first terminal, and the discovery response message is used to enable the second terminal to determine that the first terminal is discovered; and the second terminal receives the discovery response message that carries the ID of the activity and is sent by the first terminal.

Such a manner is a manner in which the second terminal actively searches for the first terminal, and sends a discovery request message; when a nearby first terminal receives the discovery request message, the first terminal may return a discovery response message; and after receiving the discovery response message sent by the first terminal, the second terminal determines that the first terminal is nearby, and sign-in can be performed.

A second manner: the first terminal broadcasts a sign-in paging message carrying the ID of the activity, where the sign-in paging message is used to indicate that the first terminal pages another terminal to sign in to the activity; and the second terminal receives the sign-in paging message that carries the ID of the activity and is broadcast by the first terminal.

Such a manner is a manner in which the first terminal actively searches for the second terminal, and sends a sign-in paging message carrying the ID of the activity; once the second terminal receives the sign-in paging message, the second terminal may determine that the first terminal is nearby, and sign-in can be performed.

Optionally, after the first terminal receives the sign-in request message in S11 in the foregoing, the method further includes that the first terminal adds a sign-in mark to the ID of the user of the second terminal, where the ID of the user of the second terminal is included in the sign-in request message.

Before the first terminal receives the sign-in request message in S11 in the foregoing, the method further includes that the first terminal acquires an ID of each user participating in the activity; and after the first terminal receives the sign-in request message in S11, the method further includes that, when the ID of the activity carried in the received sign-in request message is consistent with the acquired ID of the activity, the first terminal adds a sign-in mark to the ID of the user of the second terminal, where the ID of the user of the second terminal is included in the sign-in request message.

Optionally, after the second terminal signs in to the first terminal, the method may further include that, in a process in which the user of the second terminal participates in the activity, the second terminal may further send a heartbeat report message (keep alive report) to the first terminal according to a set time period; if the first terminal receives, within specified duration, the heartbeat report message sent by the second terminal, the first terminal sends a heartbeat acknowledgement message (Ack) to the second terminal; and if the first terminal does not receive, within the specified duration, the heartbeat report message sent by the second terminal, the first terminal determines that the user using the second terminal leaves the activity, and adds a leave mark to the ID of the user using the second terminal.

A manner for sending a heartbeat report message may be used to monitor whether the user using the second terminal is still at an activity site; and if the first terminal receives the heartbeat report message within the specified duration, it indicates that the user using the second terminal is still at the activity site; otherwise, it indicates that the user of the second terminal is not at the activity site. Once it is determined that the user of the second terminal leaves the activity, the leave mark may be added to the ID of the user of the second terminal, and further, a leaving time of the user of the second terminal may also be marked.

The set time period and set duration may be set according to an actual need; when high precision is required, the set time period and the set duration may be set to be short; otherwise, the set time period and the set duration may be set to be long.

Optionally, after the second terminal signs in to the first terminal, the method further includes that the first terminal obtains an end time of the activity; and notifies, within set duration (where the set duration may be set according to a need, or may be 0, that is, after the end time arrives) after the end time arrives, the second terminal that the activity ends, and collects, according to a quantity of IDs of users that have the sign-in mark and the leave mark, statistics about a level of participation of the users in the activity; and the second terminal receives a notification message that is sent by the first terminal and is used to notify the second terminal that the activity ends.

The first terminal may notify, within the set duration after the end time arrives, the second terminal that the activity has ended, and the second terminal may no longer send any message to the first terminal; in this case, the first terminal may collect, according to the quantity of the IDs of the users that have the sign-in mark and the leave mark, statistics about the level of participation of the users in the activity. The set duration after the end time arrives may be set according to an actual need.

Names of the messages, such as the sign-in request message, the sign-in response message, the discovery request message, the discovery response message, and the sign-in paging message, that are involved in this embodiment of the present disclosure are only an exemplary description of names of messages, or names of other messages having a same effect or function may be used, which is not limited in this embodiment of the present disclosure.

Based on a same inventive concept, an embodiment of the present disclosure provides a sign-in method. The method is performed by a first terminal, namely, a terminal used by an organizer. A process of the method is shown in FIG. 3, and steps are performed as follows.

S30: The first terminal receives a sign-in request message sent by a second terminal, where the sign-in request message carries an ID of an activity and an ID of a user of the second terminal, and the sign-in request message is used to indicate that the user of the second terminal requests to sign in to the activity in the first terminal.

S31: The first terminal sends a sign-in response message to the second terminal, where the sign-in response message carries the ID of the activity, and the sign-in response message is used to indicate that the user of the second terminal successfully signs in to the activity in the first terminal.

The first terminal receives, using a WiFi network, the sign-in request message that is sent by the second terminal using the WiFi network; and sends the sign-in response message to the second terminal using the WiFi network.

Preferably, before the first terminal receives the sign-in request message in S30 in the foregoing, the method further includes that the first terminal acquires the ID of the activity and a start time of the activity.

That the first terminal receives the sign-in request message in S30 in the foregoing includes that the first terminal receives the sign-in request message at or after a set moment before the start time of the activity arrives.

Optionally, before the first terminal receives the sign-in request message in S30 in the foregoing, the method further includes that the first terminal sends the acquired ID of the activity and the acquired start time of the activity to the second terminal.

Optionally, after the first terminal receives the sign-in request message in S30 in the foregoing, and before the first terminal sends the sign-in response message, the method further includes that the first terminal authenticates validity of the ID of the user of the second terminal.

Optionally, before the first terminal receives the sign-in request message in S30 in the foregoing, the method further includes that the first terminal receives a discovery request message that carries the ID of the activity and is sent by the second terminal, and sends, to the second terminal, a discovery response message carrying the ID of the activity, where the discovery request message is used by the second terminal to discover the first terminal, and the discovery response message is used to enable the second terminal to determine that the first terminal is discovered; or the first terminal broadcasts a sign-in paging message carrying the ID of the activity, where the sign-in paging message is used to indicate that the first terminal pages another terminal to sign in to the activity.

Optionally, after the first terminal receives the sign-in request message in S30 in the foregoing, the method further includes that the first terminal adds a sign-in mark to the ID of the user of the second terminal, where the ID of the user of the second terminal is included in the sign-in request message.

Optionally, after the first terminal sends the sign-in response message to the second terminal in S31 in the foregoing, the method further includes that, if the first terminal does not receive, within specified duration, a heartbeat report message sent by the second terminal, the first terminal determines that the user of the second terminal leaves the activity, and adds a leave mark to the ID of the user of the second terminal.

Optionally, the method further includes that, after the activity ends, the first terminal collects, according to a quantity of IDs of users that have the sign-in mark and the leave mark, statistics about a level of participation of the users in the activity.

An example is used in the following to describe in detail about collecting statistics about a level of participation of a user in an activity.

In both planned and unplanned scenarios, the first terminal may acquire IDs of all users of the second terminal that participate in the activity, and collect statistics about a level of participation of the IDs of all the users of the second terminal.

In a sign-in process, the first terminal adds the sign-in mark to the ID of the user of the second terminal, where the ID of the user of the second terminal is included in the received sign-in request message. After the activity starts, if the first terminal does not receive, within the specified duration, the heartbeat report message sent by the second terminal, the first terminal determines that the user of the second terminal leaves the activity, and adds the leave mark to the ID of the user of the second terminal.

The first terminal may collect, according to the IDs of all the users of the second terminal that participate in the activity, and IDs of users of the second terminal that have the sign-in mark, statistics about users of the second terminal that participate in the activity and users of the second terminal that do not participate in the activity; and the first terminal may collect, according to the IDs of the users of the second terminal that have the sign-in mark and the leave mark, statistics about arrival times, leaving times, duration for participating the activity, and the like of the users of the second terminal.

In the planned scenario, the first terminal can collect statistics about attendance information, such as attendance, absence, late arrival, or early leaving, of the users of the second terminal. In the planned scenario, the first terminal can also collect statistics about a quantity of participants in the activity, leaving times, participation duration, and the like of the users of the second terminal, so as to further analyze an organization situation, advantage, disadvantage, and the like of the activity.

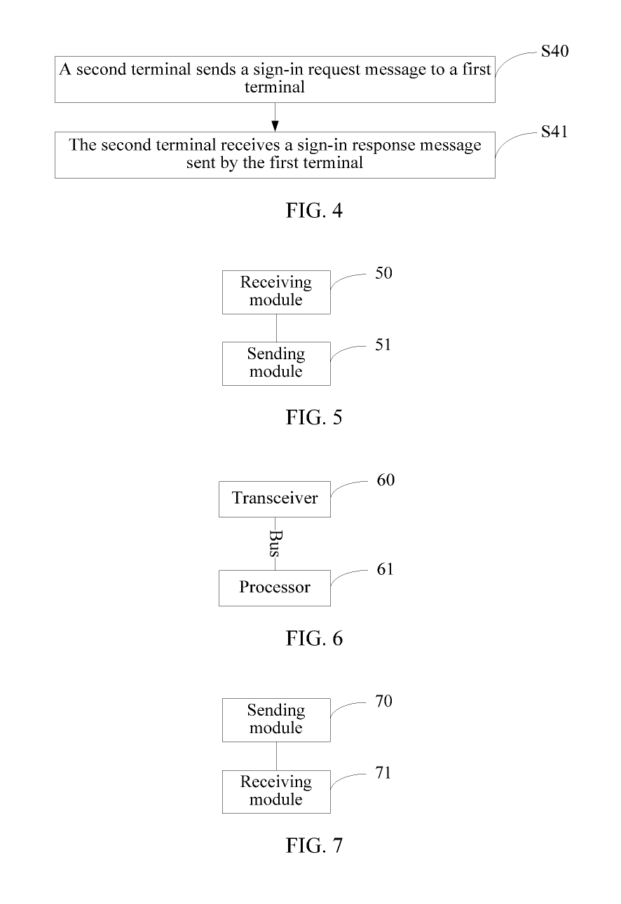

Based on a same inventive concept, an embodiment of the present disclosure provides a sign-in method. The method is performed by a second terminal, namely, a terminal used by a participant. A process of the method is shown in FIG. 4, and steps are performed as follows.

S40: The second terminal sends a sign-in request message to a first terminal, where the sign-in request message carries an ID of an activity and an ID of a user of the second terminal, and the sign-in request message is used to indicate that the user of the second terminal requests to sign in to the activity in the first terminal.

S41: The second terminal receives a sign-in response message sent by the first terminal, where the sign-in response message carries the ID of the activity, and the sign-in response message is used to indicate that the user of the second terminal successfully signs in to the activity in the first terminal.

The second terminal sends the sign-in request message to the first terminal using a WiFi network; and receives, using the WiFi network, the sign-in response message that is sent by the first terminal using the WiFi network.

Optionally, before the second terminal sends the sign-in request message to the first terminal in S40 in the foregoing, the method further includes that the second terminal acquires a start time of the activity.

That the second terminal sends the sign-in request message to the first terminal in S40 in the foregoing includes that the second terminal sends the sign-in request message to the first terminal at or after a set moment before the start time of the activity arrives.

The ID of the activity carried in the sign-in request message that is sent by the second terminal to the first terminal is sent by the first terminal to the second terminal.

Optionally, before the second terminal sends the sign-in request message to the first terminal in S40 in the foregoing, the method further includes that the second terminal sends, to the first terminal, a discovery request message carrying the ID of the activity, and receives a discovery response message that carries the ID of the activity and is sent by the first terminal, where the discovery request message is used by the second terminal to discover the first terminal, and the discovery response message is used to enable the second terminal to determine that the first terminal is discovered; or the second terminal receives a sign-in paging message that carries the ID of the activity and is broadcast by the first terminal, where the sign-in paging message is used to indicate that the first terminal pages another terminal to sign in to the activity.

Optionally, after the second terminal receives the sign-in response message sent by the first terminal in S41 in the foregoing, the method further includes that, in a process in which the user of the second terminal participates in the activity, the second terminal sends a heartbeat report message to the first terminal according to a set time period, and receives a heartbeat acknowledgement message sent by the first terminal.

Optionally, after the second terminal receives the sign-in response message sent by the first terminal in S41 in the foregoing, the method further includes that the second terminal receives a notification message that is sent by the first terminal and is used to notify the second terminal that the activity has ended.

Based on a same inventive concept, an embodiment of the present disclosure provides a first type of terminal, a structure is shown in FIG. 5, and the terminal includes a receiving module 50 configured to receive a sign-in request message sent by a second terminal, where the sign-in request message carries an ID of an activity and an ID of a user of the second terminal, and the sign-in request message is used to indicate that the user of the second terminal requests to sign in to the activity in the first terminal in which the user is located; and a sending module 51 configured to send a sign-in response message to the second terminal, where the sign-in response message carries the ID of the activity, and the sign-in response message is used to indicate that the user of the second terminal successfully signs in to the activity in the first terminal.

The receiving module 50 is configured to receive, using a WiFi network, the sign-in request message that is sent by the second terminal using the WiFi network; and the sending module 51 is configured to send the sign-in response message to the second terminal using the WiFi network.

Preferably, based on the terminal shown in FIG. 5, the terminal further includes an acquiring module configured to acquire the ID of the activity and a start time of the activity before the receiving module receives the sign-in request message; and the receiving module 50 is configured to receive the sign-in request message at or after a set moment before the start time of the activity arrives.

Preferably, the sending module 51 is further configured to send, before the receiving module receives the sign-in request message, the ID of the activity and the start time of the activity that are acquired by the acquiring module to the second terminal.

Preferably, based on the terminal shown in FIG. 5, the terminal further includes an authentication module configured to authenticate validity of the ID of the user of the second terminal after the receiving module receives the sign-in request message and before the sending module sends the sign-in response message.

Preferably, the receiving module 50 is further configured to receive, before receiving the sign-in request message, a discovery request message that carries the ID of the activity and is sent by the second terminal, where the discovery request message is used by the second terminal to discover the first terminal; and the sending module 51 is further configured to send, to the second terminal before the receiving module 50 receives the sign-in request message, a discovery response message carrying the ID of the activity, where the discovery response message is used to enable the second terminal to determine that the first terminal is discovered.

Preferably, the sending module 51 is further configured to broadcast a sign-in paging message carrying the ID of the activity, where the sign-in paging message is used to indicate that the first terminal pages another terminal to sign in to the activity.

Preferably, based on the terminal shown in FIG. 5, the terminal further includes a sign-in module configured to add, after the receiving module 50 receives the sign-in request message, a sign-in mark to the ID of the user of the second terminal, where the ID of the user of the second terminal is included in the sign-in request message.

Preferably, the sign-in module is further configured to, after the sending module 51 sends the sign-in response message to the second terminal, if a heartbeat report message sent by the second terminal is not received within specified duration, determine that the user of the second terminal leaves the activity, and add a leave mark to the ID of the user of the second terminal.

Preferably, the sign-in module is further configured to, after the activity ends, collect, according to a quantity of IDs of users that have the sign-in mark and the leave mark, statistics about a level of participation of the users in the activity.

An exemplary implementation manner of a first type of terminal is introduced in the following. A structure of the terminal is shown in FIG. 6, and the terminal includes a transceiver 60 configured to receive a sign-in request message sent by a second terminal, where the sign-in request message carries an ID of an activity and an ID of a user of the second terminal, and the sign-in request message is used to indicate that the user of the second terminal requests to sign in to the activity in a first terminal in which the terminal is located; and send a sign-in response message to the second terminal, where the sign-in response message carries the ID of the activity, and the sign-in response message is used to indicate that the user of the second terminal successfully signs in to the activity in the first terminal; and a processor 61 configured to process the sign-in request message received by the transceiver 60, and generate the sign-in response message, where the transceiver 60 is connected to the processor 61 by a bus.

The transceiver 60 receives, using a WiFi network, the sign-in request message that is sent by the second terminal using the WiFi network; and sends the sign-in response message to the second terminal using the WiFi network.

Preferably, the processor 61 is further configured to acquire the ID of the activity and a start time of the activity before the transceiver 60 receives the sign-in request message; and the transceiver 60 is configured to receive the sign-in request message at or after a set moment before the start time of the activity arrives.

Preferably, the transceiver 60 is further configured to send, before receiving the sign-in request message, the acquired ID of the activity and the acquired start time of the activity to the second terminal.

Preferably, the processor 61 is configured to authenticate validity of the ID of the user of the second terminal after the transceiver 60 receives the sign-in request message and before the transceiver 60 sends the sign-in response message.

Preferably, the transceiver 60 is further configured to, before receiving the sign-in request message, receive a discovery request message that carries the ID of the activity and is sent by the second terminal, and send, to the second terminal, a discovery response message carrying the ID of the activity, where the discovery request message is used by the second terminal to discover the first terminal, and the discovery response message is used to enable the second terminal to determine that the first terminal is discovered; or broadcast a sign-in paging message carrying the ID of the activity, where the sign-in paging message is used to indicate that the first terminal pages another terminal to sign in to the activity.

Preferably, the processor 61 is further configured to add, after the transceiver 60 receives the sign-in request message, a sign-in mark to the ID of the user of the second terminal, where the ID of the user of the second terminal is included in the sign-in request message.

Preferably, the transceiver 60 is further configured to, after the transceiver 60 sends the sign-in response message to the second terminal, if a heartbeat report message sent by the second terminal is not received within specified duration, determine that the user of the second terminal leaves the activity, and add a leave mark to the ID of the user of the second terminal.

The processor 61 is further configured to, after the activity ends, collect, according to a quantity of IDs of users that have the sign-in mark and the leave mark, statistics about a level of participation of the users in the activity.

Based on a same inventive concept, an embodiment of the present disclosure provides a second type of terminal. A structure of the terminal is shown in FIG. 7, and the terminal includes a sending module 70 configured to send a sign-in request message to a first terminal, where the sign-in request message carries an ID of an activity and an ID of a user of a second terminal in which the terminal is located, and the sign-in request message is used to indicate that the user of the second terminal requests to sign in to the activity in the first terminal; and a receiving module 71 configured to receive a sign-in response message sent by the first terminal, where the sign-in response message carries the ID of the activity, and the sign-in response message is used to indicate that the user of the second terminal successfully signs in to the activity in the first terminal.

The sending module 70 is configured to send the sign-in request message to the first terminal using the WiFi network; and the receiving module 71 is configured to receive, using the WiFi network, the sign-in response message that is sent by the first terminal using the WiFi network.

Preferably, based on the terminal shown in FIG. 7, the terminal further includes an acquiring module configured to acquire a start time of the activity before the sending module sends the sign-in request message to the first terminal; and the sending module 70 is configured to send the sign-in request message to the first terminal at or after a set moment before the start time of the activity arrives.

The ID of the activity carried in the sign-in request message that is sent by the sending module 70 to the first terminal is sent by the first terminal to the second terminal.

Preferably, the sending module 70 is further configured to send, to the first terminal before sending the sign-in request message to the first terminal, a discovery request message carrying the ID of the activity, where the discovery request message is used by the second terminal to discover the first terminal; and the receiving module 71 is further configured to receive, before the sending module 70 sends the sign-in request message to the first terminal, a discovery response message that carries the ID of the activity and is sent by the first terminal, where the discovery response message is used to enable the second terminal to determine that the first terminal is discovered.

Preferably, the receiving module 71 is further configured to receive a sign-in paging message that carries the ID of the activity and is broadcast by the first terminal, where the sign-in paging message is used to indicate that the first terminal pages another terminal to sign in to the activity.

Preferably, the sending module 70 is further configured to, after the receiving module 71 receives the sign-in response message sent by the first terminal, in a process in which the user of the second terminal participates in the activity, send a heartbeat report message to the first terminal according to a set time period; and the receiving module 71 is further configured to receive a heartbeat acknowledgement message sent by the first terminal.

Preferably, the receiving module 71 is further configured to receive, after receiving the sign-in response message sent by the first terminal, a notification message that is sent by the first terminal and is used to notify the second terminal that the activity has ended.

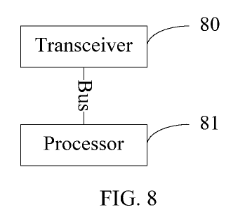

An exemplary implementation manner of a second type of terminal is introduced in the following. A structure of the terminal is shown in FIG. 8, and the terminal includes a transceiver 80 configured to send a sign-in request message to a first terminal, where the sign-in request message carries an ID of an activity and an ID of a user of a second terminal in which the terminal is located, and the sign-in request message is used to indicate that the user of the second terminal requests to sign in to the activity in the first terminal; and receive a sign-in response message sent by the first terminal, where the sign-in response message carries the ID of the activity, and the sign-in response message is used to indicate that the user of the second terminal successfully signs in to the activity in the first terminal; and a processor 81 configured to generate the sign-in request message, and process the sign-in response message received by the transceiver 80, where the transceiver 80 is connected to the processor 81 by a bus.

The transceiver 80 sends the sign-in request message to the first terminal using a WiFi network; and receives, using the WiFi network, the sign-in response message that is sent by the first terminal using the WiFi network.

Preferably, the processor 81 is further configured to acquire a start time of the activity before the transceiver 80 sends the sign-in request message to the first terminal; and the transceiver 80 is configured to send the sign-in request message to the first terminal at or after a set moment before the start time of the activity arrives.

The ID of the activity carried in the sign-in request message that is sent by the transceiver 80 to the first terminal is sent by the first terminal to the second terminal.

Preferably, the transceiver 80 is further configured to send, to the first terminal before sending the sign-in request message to the first terminal, a discovery request message carrying the ID of the activity, and receive a discovery response message that carries the ID of the activity and is sent by the first terminal, where the discovery request message is used by the second terminal to discover the first terminal, and the discovery response message is used to enable the second terminal to determine that the first terminal is discovered; or receive a sign-in paging message that carries the ID of the activity and is broadcast by the first terminal, where the sign-in paging message is used to indicate that the first terminal pages another terminal to sign in to the activity.

Preferably, the transceiver 80 is further configured to, after receiving the sign-in response message sent by the first terminal, in a process in which the user of the second terminal participates in the activity, send a heartbeat report message to the first terminal according to a set time period; and receive a heartbeat acknowledgement message sent by the first terminal.

Preferably, the transceiver 80 is further configured to receive, after receiving the sign-in response message sent by the first terminal, a notification message that is sent by the first terminal and is used to notify the second terminal that the activity has ended.

A person skilled in the art may make various modifications and variations to the present disclosure without departing from the scope of the present disclosure. In this way, the present disclosure is intended to cover these modifications and variations provided that these modifications and variations to the present disclosure fall within the scope of the claims of the present disclosure and their equivalent technologies.

What is claimed is:

1. A sign-in method, comprising:
receiving, by a first terminal, a sign-in request message sent by a second terminal, wherein the sign-in request message carries an identifier (ID) of an activity and an ID of a user of the second terminal, and wherein the sign-in request message is used to indicate that the user of the second terminal requests to sign in to the activity in the first terminal; and
sending a sign-in response message to the second terminal, wherein the sign-in response message carries the ID of the activity, and wherein the sign-in response message is used to indicate that the user of the second terminal successfully signs in to the activity in the first terminal.

2. The method according to claim 1, wherein before receiving, by the first terminal, the sign-in request message, the method further comprises acquiring, by the first terminal, the ID of the activity and a start time of the activity, and wherein receiving, by the first terminal, the sign-in request message comprises receiving, by the first terminal, the sign-in request message at or after a set moment before the start time of the activity arrives.

3. The method according to claim 2, wherein before receiving, by the first terminal, the sign-in request message, the method further comprises sending, by the first terminal, the acquired ID of the activity and the acquired start time of the activity to the second terminal.

4. The method according to claim 1, wherein before receiving, by the first terminal, the sign-in request message, the method further comprises at least one of:
receiving, by the first terminal, a discovery request message that carries the ID of the activity and is sent by the second terminal, and sending, to the second terminal, a discovery response message carrying the ID of the activity, wherein the discovery request message is used by the second terminal to discover the first terminal, and wherein the discovery response message is used to enable the second terminal to determine that the first terminal is discovered; and
broadcasting, by the first terminal, a sign-in paging message carrying the ID of the activity, wherein the sign-in paging message is used to indicate that the first terminal pages another terminal to sign in to the activity.

5. The method according to claim 1, wherein after receiving, by the first terminal, the sign-in request message, the method further comprises adding, by the first terminal, a sign-in mark to the ID of the user of the second terminal, wherein the ID of the user of the second terminal is comprised in the sign-in request message.

6. The method according to claim 5, wherein after sending, by the first terminal, the sign-in response message to the second terminal, the method further comprises:
determining, by the first terminal, that the user of the second terminal leaves the activity when the first terminal does not receive a heartbeat report message sent by the second terminal within a specified duration; and
adding a leave mark to the ID of the user of the second terminal.

7. The method according to claim 6, further comprising collecting, after the activity ends, by the first terminal according to a quantity of IDs of users that have the sign-in mark and the leave mark, statistics about a level of participation of the users in the activity.

8. A sign-in method, comprising:
sending, by a second terminal, a sign-in request message to a first terminal, wherein the sign-in request message carries an identifier (ID) of an activity and an ID of a user of the second terminal, and wherein the sign-in request message is used to indicate that the user of the second terminal requests to sign in to the activity in the first terminal; and
receiving a sign-in response message sent by the first terminal, wherein the sign-in response message carries the ID of the activity, and wherein the sign-in response message is used to indicate that the user of the second terminal successfully signs in to the activity in the first terminal.

9. The method according to claim 8, wherein before sending, by the second terminal, the sign-in request message to the first terminal, the method further comprises at least one of:
sending, by the second terminal to the first terminal, a discovery request message carrying the ID of the activity, and receiving a discovery response message that carries the ID of the activity and is sent by the first terminal, wherein the discovery request message is used by the second terminal to discover the first terminal, and wherein the discovery response message is used to enable the second terminal to determine that the first terminal is discovered; and
receiving, by the second terminal, a sign-in paging message that carries the ID of the activity and is broadcast by the first terminal, wherein the sign-in paging message is used to indicate that the first terminal pages another terminal to sign in to the activity.

10. The method according to claim 8, wherein after receiving, by the second terminal, the sign-in response message sent by the first terminal, the method further comprises:
sending, by the second terminal, a heartbeat report message to the first terminal according to a set time period in a process in which the user of the second terminal participates in the activity; and
receiving a heartbeat acknowledgement message sent by the first terminal.

11. A terminal, comprising:
a receiving module configured to receive a sign-in request message sent by a second terminal, wherein the sign-in request message carries an identifier (ID) of an activity and an ID of a user of the second terminal, and wherein the sign-in request message is used to indicate that the user of the second terminal requests to sign in to the activity in a first terminal in which the terminal is located; and
a sending module configured to send a sign-in response message to the second terminal, wherein the sign-in response message carries the ID of the activity, and wherein the sign-in response message is used to indicate that the user of the second terminal successfully signs in to the activity in the first terminal.

12. The terminal according to claim 11, wherein the receiving module is further configured to receive, before receiving the sign-in request message, a discovery request message that carries the ID of the activity and is sent by the second terminal, wherein the discovery request message is used by the second terminal to discover the first terminal, wherein the sending module is further configured to send, to the second terminal before the receiving module receives the sign-in request message, a discovery response message carrying the ID of the activity, and wherein the discovery response message is used to enable the second terminal to determine that the first terminal is discovered.

13. The terminal according to claim 11, wherein the sending module is further configured to broadcast a sign-in paging message carrying the ID of the activity, and wherein the sign-in paging message is used to indicate that the first terminal pages another terminal to sign in to the activity.

14. The terminal according to claim 11, wherein the terminal further comprises a sign-in module configured to add, after the receiving module receives the sign-in request message, a sign-in mark to the ID of the user of the second terminal, wherein the ID of the user of the second terminal is comprised in the sign-in request message.

15. The terminal according to claim 14, wherein, after the sending module sends the sign-in response message to the second terminal, the sign-in module is further configured to:
determine that the user of the second terminal leaves the activity when a heartbeat report message sent by the second terminal is not received within a specified duration; and
add a leave mark to the ID of the user of the second terminal.

16. The terminal according to claim 15, wherein, after the activity ends, the sign-in module is further configured to collect, according to a quantity of IDs of users that have the sign-in mark and the leave mark, statistics about a level of participation of the users in the activity.

17. A terminal, comprising:
a sending module configured to send a sign-in request message to a first terminal, wherein the sign-in request message carries an identifier (ID) of an activity and an ID of a user of a second terminal in which the terminal is located, and wherein the sign-in request message is used to indicate that the user of the second terminal requests to sign in to the activity in the first terminal; and
a receiving module configured to receive a sign-in response message sent by the first terminal, wherein the sign-in response message carries the ID of the activity, and wherein the sign-in response message is used to indicate that the user of the second terminal successfully signs in to the activity in the first terminal.

18. The terminal according to claim 17, wherein the sending module is further configured to send, to the first terminal before sending the sign-in request message to the first terminal, a discovery request message carrying the ID of the activity, wherein the discovery request message is used by the second terminal to discover the first terminal, wherein the receiving module is further configured to receive, before the sending module sends the sign-in request message to the first terminal, a discovery response message that carries the ID of the activity and is sent by the first terminal, and wherein the discovery response message is used to enable the second terminal to determine that the first terminal is discovered.

19. The terminal according to claim 17, wherein the receiving module is further configured to receive a sign-in paging message that carries the ID of the activity and is broadcast by the first terminal, wherein the sign-in paging message is used to indicate that the first terminal pages another terminal to sign in to the activity.

20. The terminal according to claim 17, wherein, after the receiving module receives the sign-in response message sent by the first terminal, the sending module is further configured to:
send a heartbeat report message to the first terminal according to a set time period in a process in which the user of the second terminal participates in the activity; and
receive a heartbeat acknowledgement message sent by the first terminal.
